(19) United States
(12) Patent Application Publication
(10) Pub. No.: US 2005/0089168 A1
(43) Pub. Date: Apr. 28, 2005

(54) Method and system for conditional access

(76) Inventor: Ragnar Kahre, Stockholm (SE)

Correspondence Address: DICKSTEIN SHAPIRO MORIN & OSHINSKY LLP, 2101 L Street, NW, Washington, DC, 20037, US

(21) Appl. No.: 10/498,086

(22) PCT Filed: Dec. 11, 2002
(86) PCT No.: PCT/SE02/02296

(30) Foreign Application Priority Data
Dec. 14, 2001 (SE) 0104229-0

(51) Int. Cl. H04N 7/167

(52) U.S. Cl. 380/211; 725/31

(57) ABSTRACT

The present invention relates to a method and a system for granting access to a system (1), in which different services are distributed over a distribution network (4). A user terminal (3) is used for decoding these services and access is granted for said user terminal (3) by means of a virtual card. The virtual card is downloaded over the distribution network (4) by means of an extra data stream (18) from a system unit 17 and is received by said user terminal (3).

### FIELD OF THE INVENTION

The present invention is related to a method and system for granting access to a system distributing different services over a distribution network, and in which a user terminal is used in order to decode theses services, in accordance with the preamble of claims 1 and 15, respectively.

### BACKGROUND OF THE INVENTION

A user of a pay-TV system is equipped with a decoder that is connected between a TV tap and a TV set at the user's premises. A main part in the system transmits encoded and uncoded signals that the decoder receives via the TV tap. The encoded and uncoded signals may represent analogue or digitally encoded and uncoded TV programmes/channels, and the decoder may then decrypt parts of or all of the encoded signals in dependence of the access rights of the user, and thereby the access rights of the decoder, i.e. which channels/programmes the user pays to gain access to.

Recent systems are often digital, i.e. the system broadcasts digital signals that are decoded by a digital decoder. An advantage with digital systems versus analogue systems is that a considerably larger amount of data may be transmitted, and thereby a considerably larger number of TV channels. The larger capacity in the digital systems also enables space for other services, for example interactive services such as games and surfing the Internet, where a user via a return channel in the system may affect and interact with what is shown on the TV set.

Common for both analogue and digital pay-TV systems is that a user has to authenticate himself to the system, and from the system receive authorization information in order to gain access to the services. This authorization to the system is in the digital-TV systems of today performed by means of a so called CA card (Conditional Access), containing a user's identity and giving access to the program selection that the user has access to (has paid for). The user inserts his CA-card into his decoder and may then start to use the decoder. Authorization information received by the decoder may include a key to a certain service that the user has ordered, and an indication of for example which channels the user has paid for and thus should have access to. If the authorization information indicates that the user has the right to watch a certain channel, the decoder decrypts this channel. The channels/services that are coded are decoded by the CA-card that opens precisely the channels and services that the user has ordered.

The CA-card in itself is a so called smart card that the user receives from the service provider. The handling of these cards is very expensive and thus a great problem for a digital-TV operator. These costs may comprise the manufacturing and distribution of the cards, but also stock keeping, administrative handling etc.

Thus there exist a need for an improved method for authorization of a user of a pay-TV system, in which the above mentioned costs relating to the handling of cards may be decreased.

### SUMMARY OF THE INVENTION

It is an object of the present invention to provide a method for authorization of a user and to grant access to a system for this user, in which method costly card handling is avoided.

In accordance with the present invention this is achieved by introducing an extra data stream that conveys a virtual card to the user's terminal. This data stream, or the virtual card, comprises the same functions as the CA-cards of today, among other things a unique user identity. Thereby costly, physical CA-cards need not be used, but can be eliminated entirely.

In accordance with a preferred embodiment the virtual card is stored in a memory in the decoding terminal of the user. Thereby a user terminal does not need to include a card reader, which gives a simplified and thereby less expensive terminal.

In accordance with another preferred embodiment, the memory consists of a flash memory, which provides the advantage that the virtual card resides in the memory even when the user terminal is turned off. Downloading of the virtual card need thus not be repeated each time a user wishes to use his/her terminal.

In accordance with still another preferred embodiment, the memory consists of a RAM memory, which provides a less expensive terminal since RAM memories generally are less expensive than for example flash memories. The disadvantage is however that the virtual card needs to be downloaded each time the terminal is turned on.

In accordance with still another embodiment the downloading of the virtual card comprises means for a more secure transfer of the card. Thereby fraud by means of interception of the sent out virtual cards is made more difficult.

In accordance with a preferred embodiment the security measure comprises encrypting the data stream. This is well known way to make interception more difficult, and thus a number of different encryption algorithms may be chosen.

In accordance with still another preferred embodiment the security measure consists in that the user has to enter a code to his user terminal before the card can be received, i.e. before the card can be decrypted. This is preferably used in combination with encryption and then gives a particularly secure transfer of virtual cards.

In accordance with still another preferred embodiment, the system unit generating the virtual cards comprises a VCD injector (Virtual Conditional Access Download), the main task of which is to generate these virtual cards. Thereby a system unit is provided that is easily adapted to a plurality of different systems.

In accordance with another preferred embodiment the user terminal comprises a set-top-box. Such set-top-boxes already exist on the market today and may advantageously be used in the present invention.

In accordance with another preferred embodiment the invention is applied in a digital TV network. Thereby a considerably improved method for authorization of users is provided, compared to methods used today in digital pay-TV network.

In accordance with another preferred embodiment the user terminal comprises a unique identity, and the extra data stream includes this unique identity. Thereby the virtual card intended for a certain user terminal may only be downloaded to that user terminal. This provides a secure way to convey the virtual card, and fraud by downloading to unauthorized user terminals is made more difficult or avoided entirely.

The present invention also relates to such a system.

Further advantages are accomplished in different aspects of the invention and will become apparent by the following detailed description.

### BRIEF DESCRIPTION OF THE DRAWINGS

FIG. 1 schematically shows the different parts of a conventional pay-TV system in accordance with the SimulCrypt architecture defined by DVB.

FIG. 2 shows the present invention in a conventional pay-TV system.

FIG. 3 shows how a virtual card in accordance with the present invention can be downloaded to a user.

### DETAILED DESCRIPTION OF THE PREFERRED EMBODIMENTS

The in the description used designation set-top-box (STB) refers to a terminal at a user's premises having a built-in decoder in order to decode incoming encrypted signals into a format suited for displaying on a TV-set.

In order to explain the use of the present invention, relevant parts of an existing pay-TV system, in which the invention may be applied, is first described. Although the present invention will be described in connection with the SimulCrypt architecture, which is the architecture that CA-systems (Conditional Access) of today utilize, a person skilled in the art realises that the invention may be used in other systems as well. The SimulCrypt architecture comprises four constituent parts: Subscriber Authorisation System (SAS) 14, EMM-injector 13 generating authorisation information, ECM-injector 11 generating control word messages, and finally a decoder module at a user's premises. These constituent parts will now be described briefly.

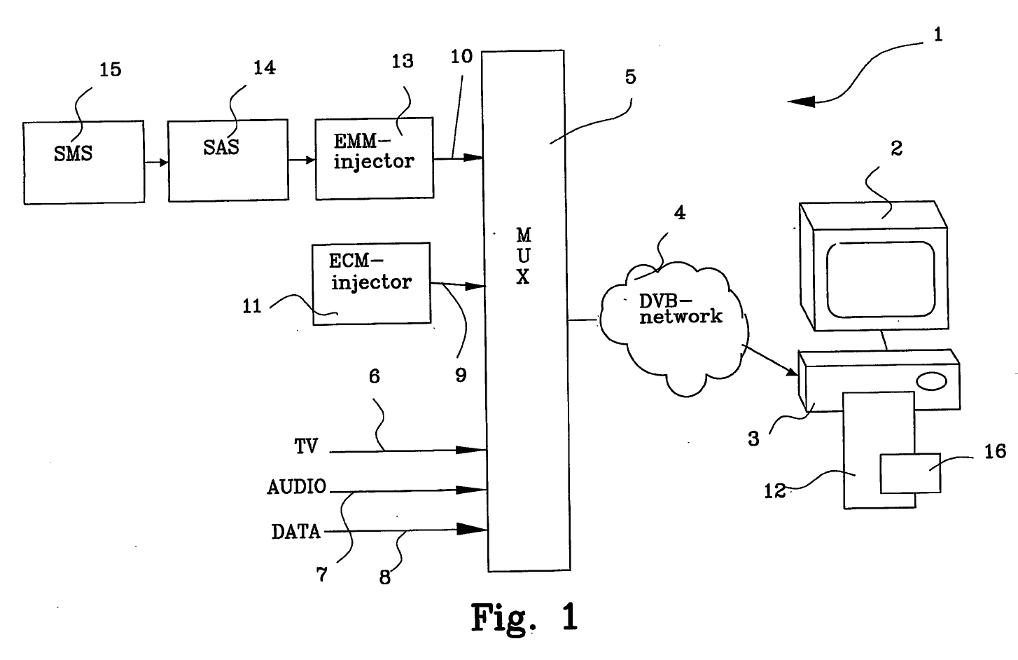

FIG. 1 shows a conventional pay-TV system 1, in which a preferred embodiment of the present invention may be applied. The system 1 comprises a TV-set 2 and a set-top-box (STB) 3 connected to the TV-set 2. Further, the STB 3 and/or the TV-set 2 is/are connected to a distribution network 4, which may consist of a terrestrial TV distribution network, a satellite TV distribution network or a cable TV network. The distribution network 4 is today often a digital distribution network, in which standards developed by DVB (Digital Video Broadcasting) are used for information transfer. The described system is essentially a unidirectional system, in which there is no return channel on which a supplier can receive a verification from a client, and nor is there a way to verify that a receiver is an authorized receiver. An unidirectional distribution network lacks the possibility to a handshake procedure in the return channel.

A multiplexer 5 is also connected to the distribution network 5, combining the information 6, 7, 8, 9, 10 to be sent via the distribution network 4 and attends to that the information 6, 7, 8, 9, 10 is broadcasted. The information 6, 7, 8, 9, 10 comprises partly the TV channels and TV programmes 6 to be broadcasted via the distribution network 4, partly radio and other audio information (for example the sound of the TV programmes) 7, partly for example games and other information 8 such as for example betting information, teletext and subtitling, and partly control information 9, 10, which will be described in detail below.

Each provider of pay-TV services has its own pay-TV system and in order to enable coexistance of several pay-TV systems in one and the same distribution network a standard called SimulCrypt has been developed in order to enable control information from several service providers to be broadcasted over the same distribution network.

A first control information 9 consists in control word messages, ECM messages (Entitlement Control Message) 9, generated in a ECM message injector 11. The ECM messages 9 include information (keys for example) in order to enable decrypting of different broadcasts (TV channels for example). A certain ECM message 9 can be broadcast often, for example several times each second, in order to be immediately available to a new viewer. A security module 12 in the STB 3 reads the ECM messages 9 together with the EMM messages 10 in order to receive authorisation and keys to decrypt the different broadcasts. The security module 12 may constitute an integrated part of the STB 3 or constitute a separate module to be inserted into the STB 3. The identity of the user is stored on a smart card, a CA card, that the user today has to receive in some way from an operator and insert into the STB 3, and that is connected to the security module 12 via a card reader. Authorisation information used in a specific STB 3 is received from one or more EMM messages 10 (Entitlement Management Message) constituting the second control information 10 and thus used in order to convey the authorities of the user to the STB. The EMM messages 10 are generated by an EMM injector 13 and contain information about a receiver's identity and which services the receiver should decrypt. The security module 12 in the STB 3 reads the EMM messages 10 in order to know what the STB 3 should decrypt and make available for the user, and then uses the ECM messages 9 as decrypting keys in order to be able to decrypt the chosen services.

The authorities that a user should have, i.e. which EMM messages 10 should be sent to a user's STB 3 is controlled by a subscriber Authorisation System, SAS 14, which is a system acting on commands from an subscriber Management System, SMS 15. The SMS 15 is a system managing user information and sending requests for activation of services to the SAS 14 that translates the information from the SMS 15 to EMM messages 10 and sees to it that the security module 12 at the user's premises receives correct authorisation in order for correct service to be decoded. The SMS 15 is more or less unique to each service provider and can be designed such that it is an operator that manually enters which users should have which services.

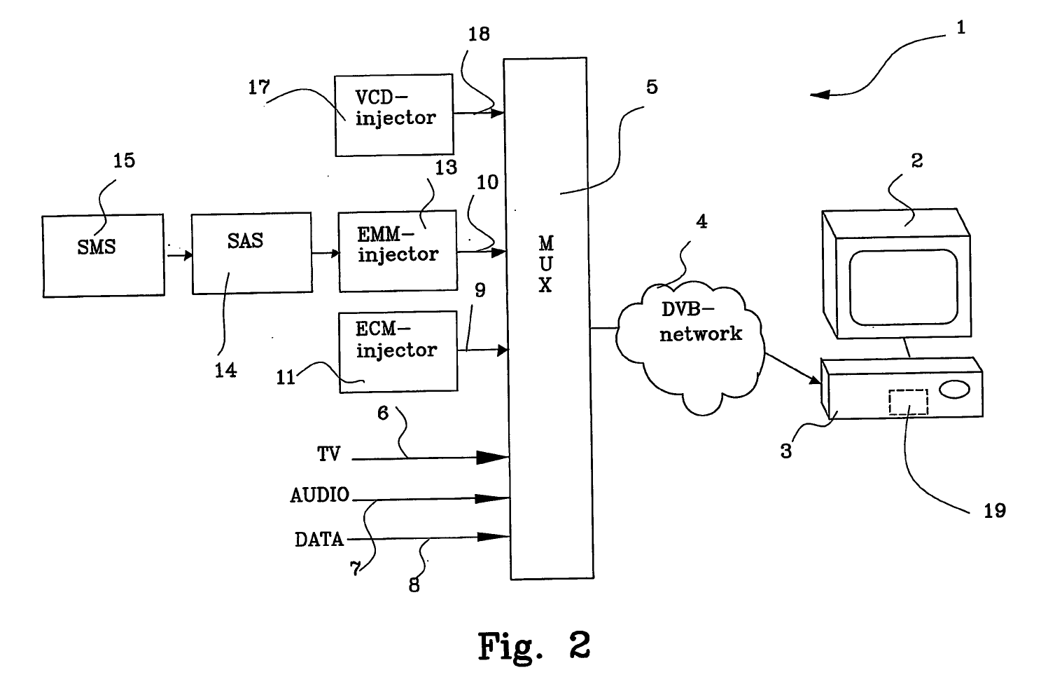

As has been described earlier, the handling of CA cards 16 constitutes a large cost for a digital TV operator. In accordance with the present invention this card is eliminated, which will now be described in detail with reference to FIG. 2.

Instead of having a digital TV operator providing a physical CA card 16 to each user, said digital TV operator has a special system node in the system, a VCD injector (Virtual Conditional Access Download) 17, the task of which is to create virtual CA cards. These virtual CA cards contain the same information and functions that are stored on the physical CA cards of today. When a new user is added a new virtual CA card is created and put in a so called carrousel, being a circular list containing items, into which the program codes for the different virtual CA cards are entered. The items remain in the list during a predetermined time period before they are removed. This time period should correspond to the time period needed for a STB 3 to be able to download the virtual CA card.

As mentioned above, it is not important for the invention which CA system that is used, the important part of the invention consists in the VCD injector 17, the main task of which being to generate the virtual CA cards. This unit may easily be adapted to different systems.

When the new user for the first time wishes to use his/her STB 3, it has to be initiated, which is done by downloading the virtual CA card to the user's STB 3. The downloading of the virtual CA card is performed by means of an extra data stream 18, here called a VCD data stream 18 (Virtual Conditional Access Download), transmitted over a distribution network to the user together with other information that the operator broadcasts. This VCD data stream 18 contains all the functions that the conventional CA cards of today contain, among other things, an identification of the user.

Information broadcast by a digital TV operator is received by a large number of STBs. A function in the STB 3 determines whether the received information is to be decoded or not, i.e. whether the user has authorization to access certain information, as was explained above. A certain STB 3 listens to the information stream, now also containing the extra VCD data stream 18, and receives the virtual CA card intended for that specific STB 3. The received virtual card is stored in a memory 19 in the STB 3, and comprises preferably a flash memory. The advantage with having a flash memory is that the virtual CA card remains in the memory even if the STB 3 is turned off. An alternative is to use an ordinary RAM memory, but then it is required that the virtual CA card is downloaded each time the STB 3 is turned on, which can be perceived as time-consuming by a user.

In order for a VCD data stream 18 not to be intercepted and downloaded by an unauthorised user, it can be protected in different ways. One way to make it more difficult for a potential eavesdropper is to encrypt the information, whereby the key being generated for encrypting and decrypting, for example, may be based on the identity number of the STB 3 and the identity of the user. There is a number of ways to encrypt information, and the choice of encrypting algorithm is not essential for the invention and is thus not described further herein.

A user may also enter a code to his/her STB 3 in order to further enhance the security.

In accordance with a preferred embodiment the user terminal includes an unique identity. The processor in a STB 3 has for example its own serial number, which serial number may be used as the unique identity of the STB 3. The hardware has in other words a unique identity. The extra VCD data stream 18 then includes also this unique identity. Thereby the virtual card intended for a certain user may only be downloaded to that particular user terminal. This provides a secure way to convey the virtual card, and fraud by means of downloading to unauthorized user terminals is made more difficult or avoided entirely.

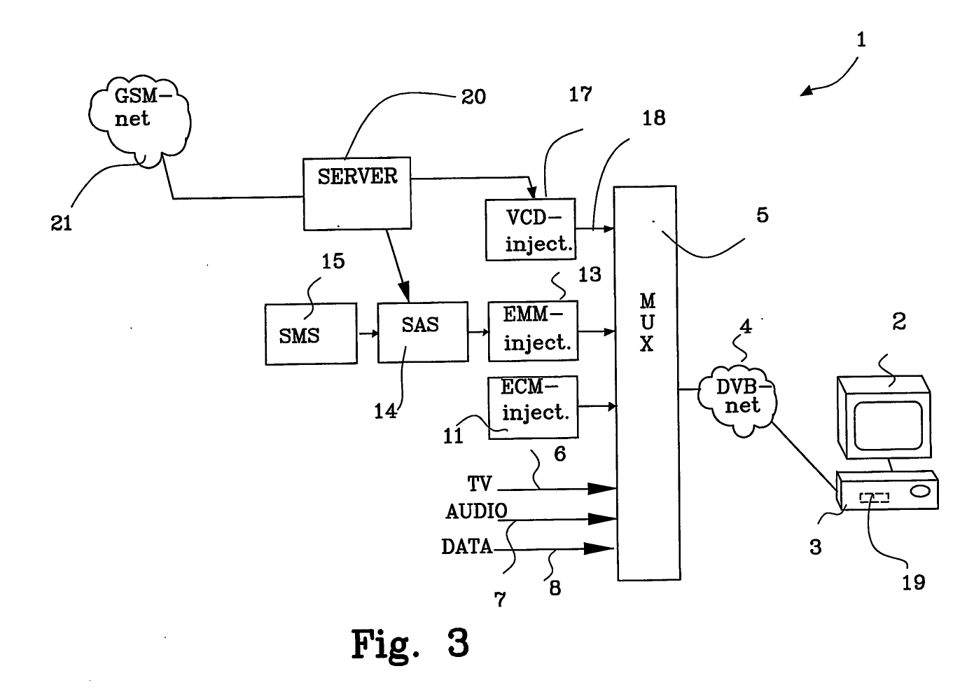

In accordance with an embodiment, shown in FIG. 3, a user wishing to download a virtual card to an optional STB 3, may do this through his/her mobile terminal. By utilizing a special server device 20, described in the pending patent application in Sweden (0103546-8, filed Oct. 24 2001, to the same applicant), a user is able to create a temporary connection between his/her mobile terminal and an optional STB 3 in the system 1. In accordance with the present invention the server device 20 is used in order to enable a user to download a virtual CA card by means of his/her mobile phone. This server device 20 has the task of opening a parallel way in order to create EMM messages 10 through the SAS 14 and with the aid of the VCD 17 create virtual CA cards to a certain STB 3, which all in all gives authorization to this STB 3 to decode a certain service (for example a TV channel). This authorisation may be temporary, an EMM message may for example be valid for only one service (a TV programme for example). The server device also handles the debiting of these services. A user wishing to download a virtual CA card in order to thereafter be able to order a service contacts the server device 20 via his/her mobile terminal and is identified via the mobile communication network. This identification includes for example that the user first identifies himself through a PIN code towards his SIM card (Subscriber Identity Module) when activating the mobile terminal, after which the SIM card is identified in the mobile communication network via the IMSI number (International Mobile Subscriber Identity) of the SIM card. In this way the mobile communication network know who the user is, and an unique user identity, for example in the form of the phone number of the user, is sent together with the set up request to the server device 20, which then uses the information as an identification and debiting basis.

When the user has established contact with the server device 20, the user states that he/she wishes to receive a virtual CA card and further an identity of the STB 3 to which the user wishes to have the virtual CA card delivered. Thereafter the server device 20 sends information to the VCD 17 about the user and which STB 3 is to receive the virtual card. Furthermore, the server device 20 may send a code to the VCD 17, which code in such case is suitably also sent to the user over the mobile communication network. The VCD 17 translates the information from the server device 20 into a virtual card and sends an encrypted VCD data stream 18 received by the intended STB 3, as was explained above. The code that the user receives over the mobile communication network is entered into the STB 3 by the user (for example via a remote control) and is checked against the code received by the STB 3 from the VCD injector 17. When these correspond to each other, the virtual CA card may be decrypted and thereby the STB 3 may begin to decrypt CA protected services. In this way a particularly secure method for transferring the virtual CA card is provided.

It is of course possible to order the virtual card in some other way, for example by means of a phone call to the operator or by letter.

1. A method for granting access to a system (1) in which different services are distributed over a distribution network (4) and in which a user terminal (3) is used to decode these services, characterised in that access is granted to said user terminal (3) by means of a virtual card, which card is downloaded over the distribution network (4) by means of an extra data stream (18) from a system unit (17) and is received by said user terminal (3).

2. Method as claimed in claim 1, characterised in that the data stream(. 18) downloading the virtual card transfers a unique user identity.

3. Method as claimed in claim 1, characterised in that the data stream (18) downloading the virtual card transfers the same functions as contained in a conventional CA card (16).

4. Method as claimed in claim 1, characterised in that the virtual card is stored in a memory (19) in the user terminal (3).

5. Method as claimed in claim 4, characterised in that said storage is effected in a flash memory.

6. Method as claimed in claim 4, characterised in that said storage is effected in a RAM memory.

7. Method as claimed in claim 1, characterised in that said downloading of the virtual card includes means for secured transfer.

8. Method as claimed in claim 7, characterised in that said means comprises encrypting.

9. Method as claimed in claim 7, characterised in that said means comprises having a user enter a code into the user terminal (3) before said virtual card may be received.

10. Method as claimed in claim 1, characterised in that said system unit is a VCD injector (17), the main task of which is to generate virtual cards.

11. Method as claimed in claim 1, characterised in that the user terminal (3) is a set-top-box (3).

12. Method as claimed in claim 1, characterised in that the distribution network (4) is a digital TV network.

13. Method as claimed in claim 1, characterised in that said services comprises at least one of the following: TV channels, TV programmes, movies or games.

14. Method as claimed in claim 1, characterised in that said downloading is ordered by a user by means of the user's mobile terminal, wherein a server device (20) connected to a mobile communication network sends an order to said server unit (17) to create a virtual card and send it to the user.

15. Method as claimed in claim 1, characterised in that said extra data stream includes a identity unique for said user terminal, by means of which said virtual card can only be downloaded to this user terminal.

16. A system distributing different services over a distribution network (4) and in which a user terminal (3) is used in order to decode these services characterised in that the system includes means for granting access to said system for said user terminal (3) by means of a virtual card, and means for downloading the virtual card over the distribution network (4) by means of an extra data stream (18) from a system unit (17) for reception by said user terminal (3).

17. System as claimed in claim 16, characterised in that the system unit arranged to download the virtual card by means of the data stream (18) transfers a'unique user identity.

18. System as claimed in claim 16, characterised in that the system unit (17) arranged to download the virtual card by means of the data stream (18) transfers the same functions as contained in a conventional CA card (16).

19. System as claimed in claim 16, characterised in that the system includes a memory (19) in the user terminal (3) in which the virtual card is stored.

20. System as claimed in claim 19, characterised in that said memory is a flash memory.

21. System as claimed in claim 19, characterised in that said memory is a RAM memory.

22. System as claimed in claim 16, characterised in that said means for downloading of the virtual card includes means for secured transfer.

23. System as claimed in claim 22, characterised in that said means for secured transfer comprises encrypting apparatus.

24. System as claimed in claim 16, characterised in that said system unit is a VCD injector (17), the main task of which is to generate virtual CA cards.

25. System as claimed in claim 16, characterised in that the user terminal (3) is a set-top-box (3).

26. System as claimed claim 16, characterised in that the distribution network (4) is a digital TV network.

27. System as claimed in claim 16, characterised in that said services comprises at least one of the following: TV channels, TV programmes, movies or games.

28. System as claimed in claim 16, characterised in that said user terminal has a unique identity and that said extra data stream includes this unique identity, by means of which said virtual card can only be downloaded to this user terminal.
